(19) United States
(12) Patent Application Publication
(10) Pub. No.: US 2004/0175297 A1
(43) Pub. Date: Sep. 9, 2004

(54) Microchemical system

(75) Inventors: Jun Yamaguchi, Sagamihara-shi (JP); Tetsuro Kawahara, Tokyo (JP); Akihiko Hattori, Sagamihara-shi (JP); Chandrasekhar Rpychoudhuri, Storrs, CT (US)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: NIPPON SHEET GLASS CO., LTD., Osaka-shi (JP)

(21) Appl. No.: 10/379,385

(22) Filed: Mar. 4, 2003

(51) Int. Cl. G01N 21/64

(52) U.S. Cl. 422/82.05

(57) ABSTRACT

A microchemical system is provided according to which to which an apparatus that is used by the microchemical system can be reduced in size, and measurement accuracy can be improved. The microchemical system 1 has an irradiation part 1a that irradiates exciting light and detecting light onto a sample solution in a channel 204 that is inside a microchemical system chip 20. The irradiation part 1a has an exciting light source 106 that outputs the exciting light, which has a wavelength of 532 nm, and a detecting light source 107 that outputs the detecting light, which has a wavelength of 635 nm. The exciting light source 106 is comprised of a fiber laser 502 that lases laser light of wavelength 1064 nm, and a poled fiber 503 that converts laser light received from the fiber laser 502 into a second harmonic. The fiber laser 502 is comprised of a laser diode 501 that lases laser light of wavelength 810 nm, and a double clad fiber 601 having fiber Bragg gratings 602a and 602b formed at opposite ends thereof. The double clad fiber 601 lases laser light of wavelength 1064 nm, taking the laser light condensed by a condensing lens 505 as a seed light source.

### BACKGROUND OF THE INVENTION

1. Field of the Invention

The present invention relates to a microchemical system, and in particular to a microchemical system that carries out photothermal conversion spectroscopic analysis.

2. Prior Art

Integration technology for carrying out chemical reactions in very small spaces has attracted attention from hitherto in view of the rapidity of chemical reactions, and the need to carry out reactions using very small amounts, on-site analysis and so on, and research into this technology has been carried out with vigor throughout the world.

As one example of such chemical reaction integration technology, there are so-called microchemical systems in which mixing, reaction, separation, extraction, detection or the like is carried out on a sample solution in a very fine channel. Examples of reactions carried out in such a microchemical system include diazotization reactions, nitration reactions, and antigen-antibody reactions; examples of extraction/separation include solvent extraction, electrophoretic separation, and column separation. A microchemical system may be used with a single function, for example for only separation, or may be used with a combination of functions.

As an example of a microchemical system for only separation out of the above functions, an electrophoresis apparatus for analyzing extremely small amounts of proteins, nucleic acids or the like has been proposed (see, for example, Japanese Laid-open Patent Publication (Kokai) No. 8-178897). This electrophoresis apparatus has a microchemical system chip comprised of two glass substrates joined together. Because the chip is plate-shaped, breakage is less likely to occur than in the case of a glass capillary tube having a circular or rectangular cross section, and hence handling is easier.

In such a microchemical system, because the amount of the sample solution is extremely small, a highly sensitive detection method is essential. As such a method, a photothermal conversion spectroscopic analysis method in which the difference in signal strength of detecting light between before and after irradiating exciting light onto a sample solution in a very fine channel (hereinafter referred to as the “TLM (thermal lens microscope) output”) is detected has been established, thus opening up a path for making microchemical systems fit for practical use.

Specifically, in the photothermal conversion spectroscopic analysis method, the detecting light is irradiated onto the sample solution before and after forming a thermal lens through irradiation of the exciting light, and the TLM output, which is the difference in the signal strength of the detecting light between before and after forming the thermal lens is detected. This method is suitable for detecting the extremely small concentration of the sample solution.

The thermal lens is formed through the density of the sample solution changing upon the temperature of the sample solution rising due to the detection-targeted component absorbing the exciting light. Consequently, to increase the TLM output to be detected, it is preferable for the wavelength of the exciting light to be a wavelength at which the detection-targeted component absorbs the exciting light well. On the other hand, if the detection-targeted component absorbs the detecting light, then the irradiation of the detecting light will also contribute to the formation of the thermal lens, and hence the detected TLM output will no longer be accurate; it is thus preferable for the wavelength of the detecting light to be a wavelength at which the detection-targeted component does not absorb the detecting light.

Moving on, to make a microchemical system smaller in size, laser diodes are used as the light sources for the exciting light and the detecting light, and moreover to make the optical axes of the exciting light and the detecting light stably coaxial without using an optical axis adjusting jig, optical fibers are used in the optical system.

However, in the case that the wavelength at which the detection-targeted component absorbs the exciting light or detecting light well is in a range of 450 to 630 nm, which is a wavelength range in which the lasing efficiency of laser diodes is poor, an apparatus such as a gas laser that is larger than a laser diode must be used, and moreover because the laser output cannot be controlled using the gas laser or the like itself, to prevent that the thermal lens formed in the sample solution loses its shape through thermal saturation, a chopper or the like that periodically switches the irradiation of the exciting light onto the sample solution on and off must be provided externally. There is thus a problem that the microchemical system increases in size.

Furthermore, in the case of externally providing a chopper or the like as described above, because the laser light is irradiated in the form of space light, the irradiated laser light is prone to being affected by external fluctuations such as temperature changes or vibrations, and hence there is a problem that the measurement accuracy worsens. Moreover, in the case of using optical fibers in the optical system, there will be a large loss in the laser output when laser light that been irradiated in the form of space light is made to enter an optical fiber.

### SUMMARY OF THE INVENTION

It is an object of the present invention to provide a microchemical system according to which an apparatus that is used by the microchemical system can be reduced in size, and measurement accuracy can be improved.

To attain the above object, a microchemical system according to the present invention comprises a transparent substrate having inside thereof a channel through which a sample solution is passed, and a light source that irradiates exciting light onto the sample solution in the channel to form a thermal lens, wherein the light source comprises a laser that lases laser light, first converting means for carrying out wavelength conversion on the laser light, and second converting means for subsequently carrying out wavelength conversion on the laser light into a second harmonic. As a result, exciting light of a wavelength that could not be lased efficiently by a laser diode can be irradiated, without using a large apparatus such as a gas laser. Consequently, the apparatus can be reduced in size, and measurement accuracy can be improved.

Preferably, the laser comprises a laser diode. As a result, the apparatus can be reduced in size reliably.

Moreover, the laser diode preferably has an output modulator that modulates the output from the laser diode. As a result, it is not necessary to externally provide a chopper or the like for controlling the output from the laser diode, but rather control of the output from the laser diode can be carried out inside the laser diode, and hence all of the optical system can be confined within an optical fiber; measurement accuracy can thus be improved, without making the apparatus large in size.

Preferably, the first converting means comprises a fiber laser, and the second converting means comprises a poled fiber. As a result, the effects described above can be achieved reliably.

Moreover, the fiber laser and the poled fiber are preferably joined together by fusion. As a result, unlike in the case of linking the fiber laser and the poled fiber together via a lens, a jig for aligning the optical axes of the fiber laser and the poled fiber is unnecessary, and moreover the efficiency of light utilization can be improved.

Preferably, in the microchemical system described above, the exciting light has a wavelength in a range of 450 to 630 nm.

The above and other objects, features, and advantages of the invention will become more apparent from the following detailed description taken in conjunction with the accompanying drawings.

### BRIEF DESCRIPTION OF THE DRAWINGS

FIG. 1 is a schematic view showing the construction of a microchemical system according to an embodiment of the present invention;

FIG. 2 is a schematic view showing the construction of an exciting light source 106 in the microchemical system 1 of FIG. 1;

FIG. 3 is a sectional view taken along line III-III across a double clad fiber 601 appearing in FIG. 2;

FIG. 4 is a sectional view of a double clad fiber 601′, which is a modification of the double clad fiber 601 in FIG. 3;

FIGS. 5A to 5C are schematic views useful in explaining a VAD method used for manufacturing the double clad fiber 601 or 601′; specifically:

FIG. 5A shows a soot producing step;

FIG. 5B shows a vitrification step; and

FIG. 5C shows a drawing step;

FIG. 6 is a view useful in explaining the formation of a preform 903 through the vitrification step in FIG. 5B;

FIG. 7 is a view useful in explaining a method of manufacturing FBGs 602a and 602b appearing in FIG. 2 using a phase mask method;

FIG. 8 is a perspective view schematically showing the construction of a poled fiber 503 appearing in FIG. 2; and

FIG. 9 is a view useful in explaining a method of manufacturing the poled fiber 503 appearing in FIG. 8.

### DETAILED DESCRIPTION OF THE PREFERRED EMBODIMENTS

An embodiment of the present invention will now be described in detail with reference to the drawings.

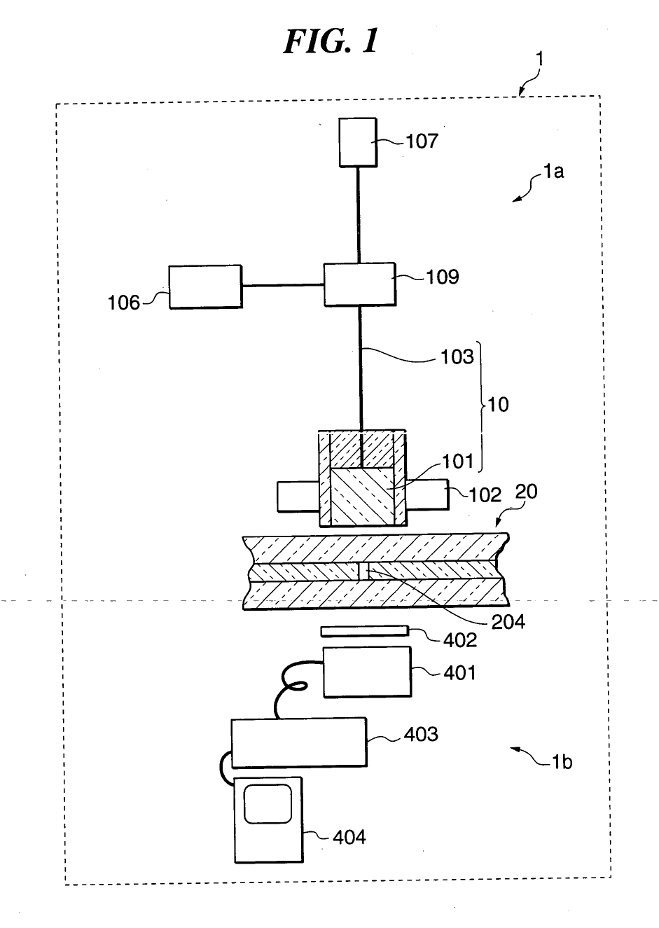

FIG. 1 is a schematic view showing the construction of a microchemical system according to an embodiment of the present invention.

In FIG. 1, the microchemical system 1 is comprised of an irradiation part 1a that irradiates exciting light and detecting light onto a sample solution in a channel 204 that is provided inside a microchemical system chip 20 and is used for carrying out mixing, agitation, synthesis, separation, extraction, detection or the like on the sample solution, and a light receiving part 1b that receives the exciting light and detecting light after the exciting light and detecting light have passed through the microchemical system chip 20.

The irradiation part 1a is comprised of an exciting light source 106 that outputs the exciting light, which has a wavelength of 532 nm, a detecting light source 107 that outputs the detecting light, which has a wavelength of 635 nm, a two-wavelength multiplexing element 109 that is connected to each of the exciting light source 106 and the detecting light source 107 via an optical fiber and multiplexes the exciting light from the exciting light source 106 and the detecting light from the detecting light source 107, a lens-possessing optical fiber 10 having an optical fiber 103 that receives the multiplexed exciting light and detecting light, and a rod lens 101 that is attached to a tip of the optical fiber 103 and irradiates the received exciting light and detecting light onto the channel 204 in the microchemical system chip 20, and a jig 102 that adjusts/maintains the position of the lens-possessing optical fiber 10 such that the lens-possessing optical fiber 10 faces the channel 204 of the microchemical system chip 20.

The light receiving part 1b is comprised of a wavelength filter 402 that receives the exciting light and detecting light after the exciting light and detecting light have passed through the microchemical system chip 20 and selectively transmits only the detecting light, a photoelectric converter 401 that detects the signal strength of the transmitted detecting light, a lock-in amplifier 403 that synchronizes the detecting light signal strength from the photoelectric converter 401 to the exciting light source 106, and a computer 404 that analyzes the signal.

Using the microchemical system 1 of FIG. 1, photothermal conversion spectroscopic analysis is carried out by detecting, with the photoelectric converter 401, the difference in the signal strength of the detecting light between before and after irradiation of the exciting light onto the sample solution in the channel 204, i.e. the difference in the signal strength of the detecting light between before and after formation of the thermal lens in the sample solution (the TLM (thermal lens microscope) output).

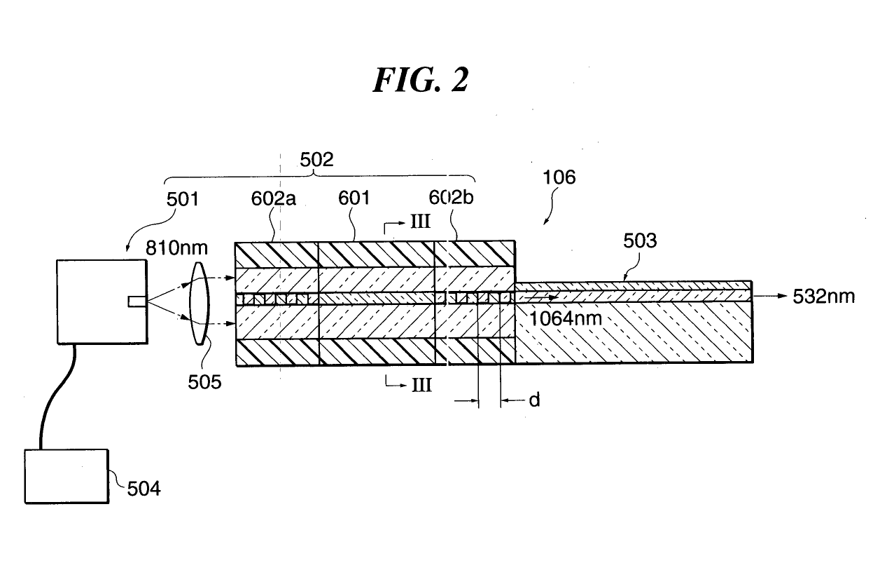

FIG. 2 is a schematic view showing the construction of the exciting light source 106 in the microchemical system 1 of FIG. 1.

In FIG. 2, the exciting light source 106 is comprised of a fiber laser 502 that lases laser light of wavelength, for example, 1064 nm, and a poled fiber 503 that is connected to the fiber laser 502, receives the lased laser light from the fiber laser 502, and converts the received laser light into the second harmonic, thus changing the wavelength to, for example, 532 nm.

The fiber laser 502 is composed of the aforementioned laser diode, e.g., a laser diode 501 that lases laser light of wavelength, for example, 810 nm, a condensing lens 505 that condenses the laser light lased by the laser diode 501, and a double clad fiber 601 having fiber Bragg gratings (FBGs) 602a and 602b formed at two ends thereof. Here, the condensing lens 505 may be omitted.

The double clad fiber 601 lases laser light of wavelength 1064 nm, taking the laser light condensed by the condensing lens 505 as a seed light source.

Moreover, an output power modulator 504 that modulates the output from the laser diode 501 is connected to the laser diode 501, and the output from the laser diode 501 is controlled by the output power modulator 504. As a result, the need to externally provide a chopper or the like for controlling the output power can be eliminated, and hence all of the optical system can be confined within an optical fiber, and thus high-accuracy measurement can be carried out without making the exciting light source 106 as a whole large in size.

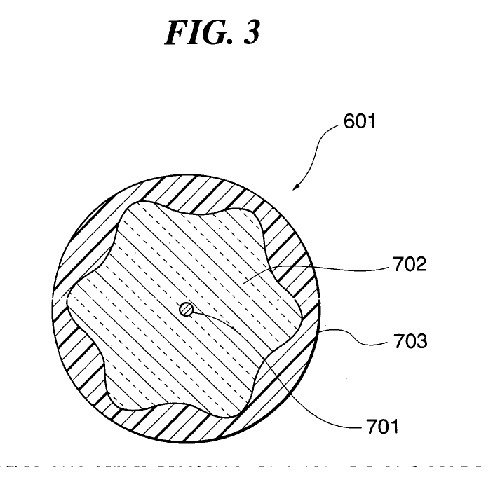

FIG. 3 is a sectional view taken along line III-III across the double clad fiber 601 in FIG. 2.

In FIG. 3, the double clad fiber 601, which is a single-mode fiber, is comprised of a core 701 that has a diameter of 7 μm and is made of SiO₂ doped with rare earth Nd, a cladding 702 that has a star-shaped cross section and is made of silica, and an outer sheath 703 that has an outside diameter of 200 μm and is made of a low-refractive-index polymer, these being formed in this order from a central axis outward.

The double clad fiber 601 has a numerical aperture (NA) in a range of 0.45 to 0.60, and the output from the double clad fiber 601 depends only on the output from the laser light from the laser diode 501.

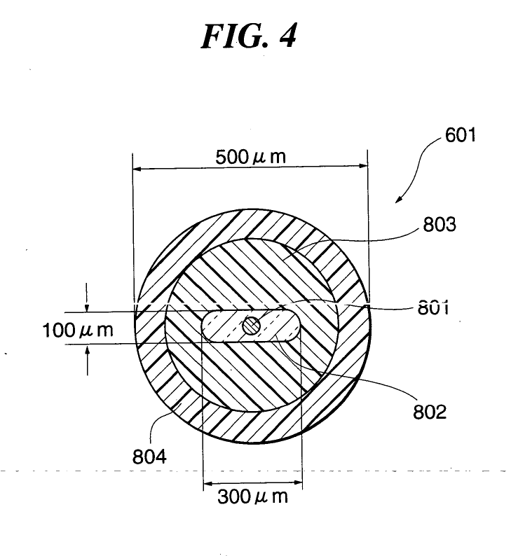

A double clad fiber 601′ as shown in FIG. 4 may be used instead of the double clad fiber 601 of FIG. 3.

FIG. 4 is a sectional view of the double clad fiber 601′, which is a modification of the double clad fiber 601 in FIG. 3.

In FIG. 4, the double clad fiber 601′, which is a single-mode fiber, is comprised of a core 801 that has a diameter of 7 μm and is made of SiO₂ doped with rare earth Nd, a cladding 802 that has a 100 μm×300 μm cross section and is made of SiO₂, a soft polymer 803 that has a diameter of 300 μm, and an outer sheath 804 that has a diameter of 500 μm and is made of a hard polymer, these being formed in this order from a central axis outward.

The double clad fiber 601′ has a numerical aperture (NA) of 0.59.

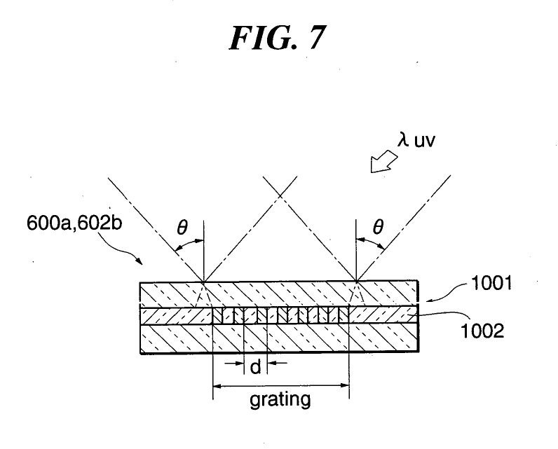

As shown in FIG. 7, the FBGs 602a and 602b in FIG. 2 provide regions in a core 1002 at opposite ends of the double clad fiber 601 or 601′ where high-refractive-index parts (having a refractive index n_{H} of, for example, n+0.001, wherein n represents the refractive index of the core 1002) and low-refractive-index parts (having a refractive index n_{L} of, for example, n) are alternately formed with a period d (e.g. 364 nm) (the period d is the length of one high-refractive-index part plus one low-refractive-index part).

The fiber laser 502 and the poled fiber 503 are joined together by fusion as in the case of joining together ordinary quartz fibers. As a result, unlike in the case of linking the fiber laser 502 and the poled fiber 503 together via a lens, a jig for aligning the optical axes of the fiber laser 502 and the poled fiber 503 is unnecessary, and moreover the efficiency of light utilization can be improved.

Each of the double clad fibers 601 and 601′ is very similar to an ordinary quartz fiber, and is manufactured using a so-called VAD (vapor-phase axial deposition) method.

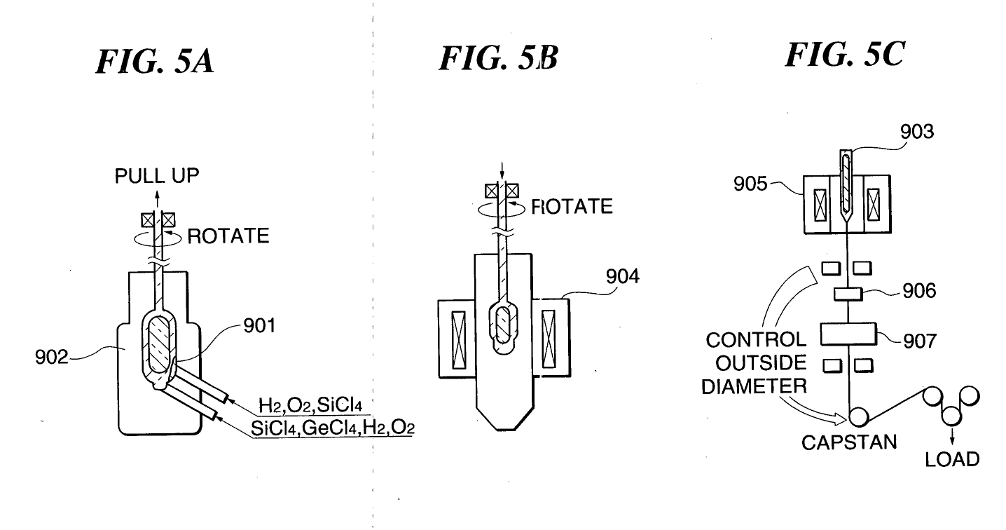

FIGS. 5A to 5C are schematic views useful in explaining the VAD method used for manufacturing the double clad fiber 601 or 601′; specifically FIG. 5A shows a soot producing step, FIG. 5B shows a vitrification step, and FIG. 5C shows a drawing step.

In the soot producing step shown in FIG. 5A, silicon tetrachloride (SiCl₄) and germanium tetrachloride (GeCl₄) are blown along with oxygen gas and hydrogen gas onto a quartz rod, which is rotating in a reaction vessel 902, from below the quartz rod, and a flame hydrolysis reaction is brought about by using a hydrogen-oxygen burner. Here, the silicon tetrachloride is a raw material of the optical fiber, and the germanium tetrachloride is a dopant for controlling the refractive index. Through the flame hydrolysis reaction, porous soot 901 grows progressively in an axial direction from the bottom of the quartz rod.

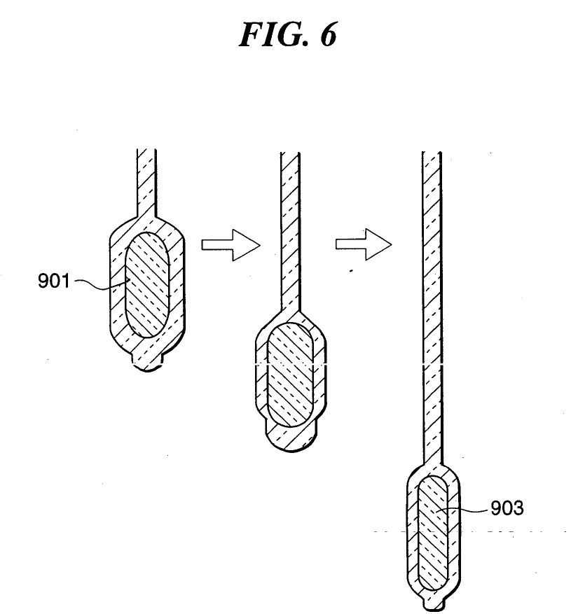

In the vitrification step shown in FIG. 5B, the quartz rod is pulled up while being rotated, and is heated by a ring-shaped heater 904. As a result, the porous soot 901 that grew in the axial direction in the soot producing step vitrifies into transparent glass, whereby a preform 903 is obtained (FIG. 6).

In the drawing step shown in FIG. 5C, the preform 903 that has been obtained through the vitrification step is melted by heating in a drawing furnace 905, and the molten preform 903 is continuously wound, thus producing a fiber. Moreover, when producing the fiber, a resin is coated onto the fiber surface in a resin coater 906, and then the resin is irradiated in a UV irradiator 907, thus bonding the resin to the fiber surface. As a result, a coated optical fiber in which the surface of the glass thereof, which is easily scratched, is protected is produced.

At the opposite of the double clad fiber 601 or 601′ manufactured as described above, FBGs 602a and 602b are formed through a phase mask method as shown in FIG. 7.

Specifically, as shown in FIG. 7, at each end of the double clad fiber 601 or 601′, diffracted UV light of wavelength 248 nm from a KrF laser is irradiated at a predetermined angle θ onto the core 1002 of the double clad fiber 601 or 601′ from the surface of the double clad fiber 601 or 601′, whereby the FBGs 602a and 602b in which the refractive index of the core 1002 alternates with a period d can be obtained.

According to the fiber laser described above, the seed light and lased light propagates while being confined within the narrow core of the fiber, and hence extremely efficient lasing is possible, and thus the fiber laser has the advantage that water cooling is not required even though the output power is high.

Next, a description will be given of the poled fiber 503 in FIG. 2.

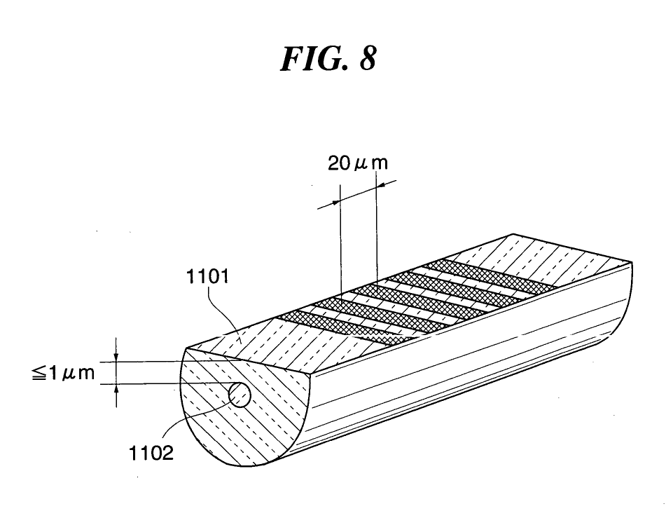

FIG. 8 is a perspective view schematically showing the construction of the poled fiber 503 appearing in FIG. 2.

In FIG. 8, the poled fiber 503 is a quartz fiber that has a longitudinally shaved-off cylindrical shape, and has a core 1102 positioned along a central axis of the cylinder, and a polished surface 1101 obtained by polishing down a peripheral side part to within not more than 1 μm from the core 1102. The core 1102 is poled at a pitch (e.g. 20 μm) that is determined in accordance with the wavelength of the laser light to be used and the properties of the quartz fiber, whereby the core 1102 is given non-linear properties.

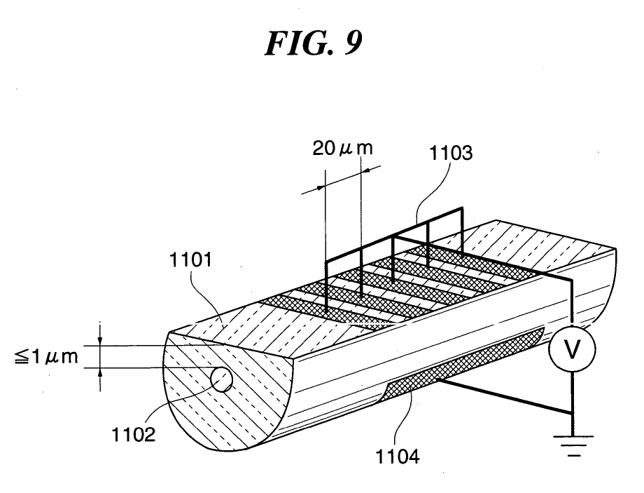

FIG. 9 is a view useful in explaining a method of manufacturing the poled fiber 503 appearing in FIG. 8.

In FIG. 9, first, a quartz fiber is shaved down into a longitudinally shaved-off cylindrical shape, and then the resulting planar part is polished, thus forming the polished surface 1101. The distance from the polished surface 1101 to the core 1102 is made to be not more than 1 μm.

Next, a comb-shaped electrode 1103 is placed against the polished surface 1101 and a membrane-like electrode 1104 is placed against a surface of the quartz fiber approximately opposite the polished surface 1101, and a high voltage is applied between the electrodes 1103 and 1104, whereby a periodically varying voltage is applied to the core 1102. The pitch between the various places where the comb-shaped electrode 1103 contacts the polished surface 1101 is determined in accordance with the wavelength of the laser light to be used and the properties of the fiber, and is, for example, approximately 20 μm.

Next, with the high voltage being applied between the electrodes 1103 and 1104, the temperature is raised to a temperature in a range of 270° C. to 280° C. As a result, glass in the vicinity of the polished surface 1101 is poled, whereby the core 1102 is given non-linear properties.

After the core 1102 has been given non-linear properties, application of the high voltage between the electrodes 1103 and 1104 is stopped, and cooling down to room temperature is carried out. After this processing, the non-linear properties remain in the core 1102 even if a high voltage is not applied again.

According to the microchemical system of the present embodiment, laser light of wavelength 810 nm is lased by the laser diode 501 of the exciting light source 106, the laser light lased by the laser diode 501 is subjected to wavelength conversion into a wavelength of 1064 nm by the fiber laser 502, which uses the laser diode 501 as a seed light source, and the laser light that has been subjected to wavelength conversion by the fiber laser 502 is subjected to conversion to a wavelength of 532 nm, which is the second harmonic, by the poled fiber 503. As a result, it is possible to efficiently obtain laser light of wavelength in a range of 450 to 630 nm, which could not generally be lased efficiently by a laser diode alone.

It should be noted that, although the wavelength of the laser light lased by the laser diode 501 is 810 nm in the present embodiment, there is no limitation to this; the laser light may be of any wavelength that can generally be lased efficiently by a laser diode. Similarly, although the fiber laser 502 outputs laser light of wavelength 1064 nm in the present embodiment, there is no limitation to this; the fiber laser 502 may output light of any wavelength, so long as the wavelength after the laser light outputted by the fiber laser 502 has been converted into the second harmonic by the poled fiber 503 is suitable as the wavelength of the exciting light.

What is claimed is:

1. A microchemical system comprising:
a transparent substrate having inside thereof a channel through which a sample solution is passed; and
a light source that irradiates exciting light onto the sample solution in said channel to form a thermal lens;
wherein said light source comprises a laser that lases laser light, first converting means for carrying out wavelength conversion on the laser light, and second converting means for subsequently carrying out wavelength conversion on the laser light into a second harmonic.

2. A microchemical system as claimed in claim 1, wherein said laser comprises a laser diode.

3. A microchemical system as claimed in claim 2, wherein said laser diode has an output power modulator that modulates an output from said laser diode.

4. A microchemical system as claimed in claim 1, wherein said first converting means comprises a fiber laser, and said second converting means comprises a poled fiber.

5. A microchemical system as claimed in claim 4, wherein said fiber laser and said poled fiber are joined together by fusion.

6. A microchemical system as claimed in claim 1, wherein the exciting light has a wavelength in a range of 450 to 630 nm.
